(19) United States
(12) Patent Application Publication
(10) Pub. No.: US 2006/0290492 A1
(43) Pub. Date: Dec. 28, 2006

(54) Gun case with alarm

(76) Inventor: Forrest P. Jidas, Brandon, MI (US)

Correspondence Address: John R. Benefiel, Suite 100 B, 280 Daines Street, Birmingham, MI, 48009, US

(21) Appl. No.: 11/475,554

(22) Filed: Jun. 27, 2006

Related U.S. Application Data
(60) Provisional application No. 60/694,841, filed on Jun. 28, 2005.

(51) Int. Cl. G08B 13/08

(52) U.S. Cl. 340/545.6

(57) ABSTRACT

An arrangement and method for storing a hand gun or rifle in which a hand gun receiving gun case is attached to a fixed structure and an audio alarm is activated whenever a lid for the gun case is opened. A concealed shut off lever allows the alarm to be turned off.

### CROSS REFERENCE TO RELATED APPLICATIONS

This application claims the benefit of U.S. provisional application Serial Number 68/694,841 filed on Jun. 28, 2005

### BACKGROUND OF INVENTION

This invention concerns hand guns particularly in the home. Keeping a hand gun in the home as for self defense presents a hazard where children are present, as many injuries and deaths have resulted from children finding hand guns and inadvertently discharging the same.

While alarms have been provided for storage cabinets, it is often desired that a gun be kept readily at hand for use in self defense, or in a night stand. While gun cases suitable for handguns are known, a child may wander off with a hand gun in a gun case and open it at some more remote location. Locks on the cases may prevent opening by a child, but might slow access to the handgun if an emergency need arises for access by the owner.

It is the object of the present invention to provide child protection for stored hand guns while providing for quick access by the owner.

### SUMMARY OF THE INVENTION

The above object and other object which will become apparent upon a reading of the following specification and claims are achieved by a portable gun case equipped with an audible alarm activated whenever the gun case is opened. The alarm is preferably a magnetic two component alarm which sounds an audible alarm when the components are separated by opening a gun case lid. One component is secured to the case lid, the other to a case receptacle side wall located adjacent to the one component so that opening the lid separates the components and triggers the audible alarm. The normally portable gun case is adapted to be detachably secured to a furniture piece or other structure. Preferably, the gun case is fixed with non marring hook and loop fastener strips which deter a child's efforts at moving the gun case but allow an adult to remove the gun case when it is desired to be moved.

The alarm can be deactivated by the owner by an arrangement which is concealed so that a child or other person cannot easily deactivate the alarm while allowing the owner to do so. Preferably, the other of the alarm components is mounted slightly spaced above the case bottom with an alarm lever disposed in that narrow space so as to not be readily seen or accessed by a child or other person not familiar with the arrangement.

### DESCRIPTION OF DRAWINGS

FIG. 1 is a pictorial view of a gun case according to the present invention detachably secured to a structure shown in fragmentary form.

FIG. 2 is a pictorial view of the gun case shown in FIG. 1.

FIG. 3 is an enlarged side view of the case mounted alarm components together with a fragmentary portion of the case receptacle and detachable mounting strips.

FIG. 4 is a diagrammatic end view of the alarm components and gun case lid and receptacle.

FIG. 5 is a bottom view of the receptacle mounted alarm component.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

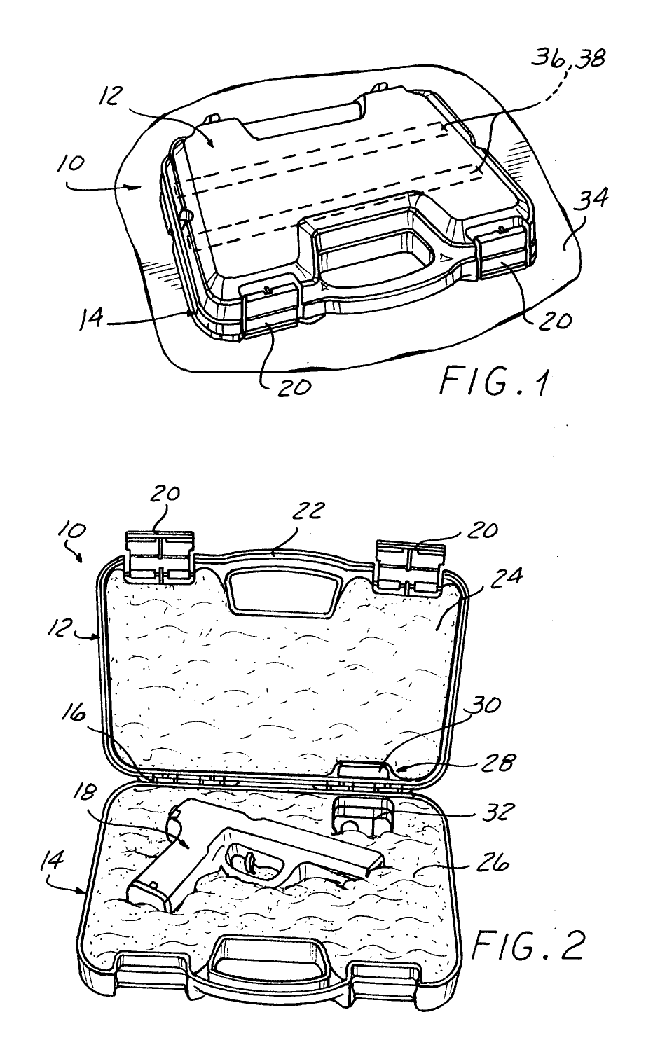

Referring to the drawings, and particularly FIGS. 1 and 2, a portable hand held gun case 10 is shown of a commercially available type comprised of a lid 12 and a lower receptacle 14. Both the lid 12 and receptacle 14 are molded plastic shells connected together along one side with a hinge 16. Contoured soft foam pads 24, 26 are inserted into the inside of each of the lid 12 and receptacle 14 which are easily compressible so that a hand gun 18 can be held in position when the lid 12 is closed and latches 20 secured on either side of a hand grip 22.

According to the concept of the present invention, an audible alarm system 28 is installed within the case 10 and adjacent the hinge sides 16 connecting the lid 12 and receptacle 14. The audible alarm may be of a commercially available type which includes a magnetic trigger component 30 attached to the lid 12 and recessed into a corner of the foam pad 24 and a main component 32 attached to the receptacle 14 recessed into a corner of the pad 26. Double faced adhesive tape can be used to mount those components.

When the magnetic trigger component 30 is positioned adjacent the main component 32, no alarm sounds, but when separated, as happens when the lid 12 is swung open to move the components 30, 32 apart, this causes an audible alarm to sound loudly. This arrangement is indicated in FIG. 4.

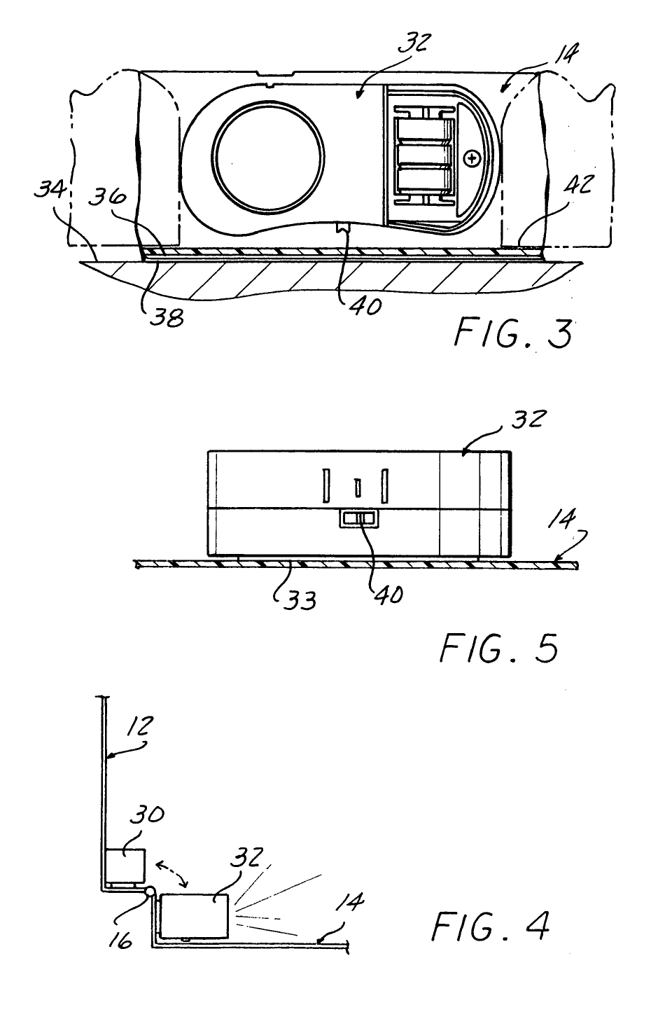

According to one aspect of the invention, the normally portable gun case 10 is securely attached to a supporting structure such as a table surface 34 as with mating hook and loop strips 36, 38 (FIGS. 1 and 3). This attachment should be quite strong, sufficient to resist the efforts of a child, but able to be overcome by an adult to allow the gun case 10 to be portable and, movable. Suitable sizing of the hook and loop strips 34, 36 enables sufficient holding power to be achieved.

Other arrangements such as screw fasteners could be used, but the hook and loop strips 36, 38 have the advantage of not permanently marring the surface 34.

According to another feature of the invention, a shut off lever 40 is provided projecting downward from the main component 32, but effectively concealed while still being accessible by spacing the main component 34 a small distance above the bottom wall 42 of the receptacle 14. The presence of the pad 26 also aids in concealment of the lever 40.

Thus, by inserting a thin tool into the space can the lever 40 be accessed.

Accordingly, the gun case 10 can be readily opened but an alarm sounded so that if a child opens the gun case 10, the owner or other adults will be alerted.

The invention can also be used with rifle cases in addition to hand guns as described.

1. A gun case including a portable receptacle to receive a gun or rifle and a lid hinged to said receptacle to enable swinging said lid open and closed over an open top of said receptacle;
an audio alarm comprised of a trigger component and a main component each mounted to one of said lid or said receptacle;
said receptacle attached to a mounting structure to make removal of said gun case from said structure difficult for a child.

2. The arrangement according to claim 1 wherein one of said alarm components is attached to a receptacle side wall adjacent said hinging side and the other component is attached to said lid so as to be disposed next to one alarm component when said lid is closed.

3. The arrangement according to claim 2 wherein a compressible pad is mounted in each of said lid and receptacle and each of said pads is cut out to receive a respective alarm component.

4. The arrangement according to claim 1 wherein one of said alarm components has a downwardly extending shut off lever and said one component is spaced narrowly above a bottom wall to allow access to said lever while concealing the same.

5. The arrangement according to claim 1 wherein said receptacle is attached to said mounting structure with hook and loop strips.

6. The arrangement according to claim 1 wherein said receptacle is attached to fixed structure by a detachable fastener which allows an adult to remove said gun case while determining a child from removing the same.

7. A method of storing a hand gun to provide access while preventing access to children comprising:
attaching a portable gun case to a fixed structure storing;
a hand gun in said gun case; and
triggering an audible alarm whenever said gun case is opened.

8. The method according to claim 7 including concealing alarm shut off lever by the mounting of an alarm component in said gun case.
